(19) United States
(12) Patent Application Publication
(10) Pub. No.: US 2020/0393801 A1
(43) Pub. Date: Dec. 17, 2020

(54) PROGRAMMABLE LOGISTICS CLOUD COMPUTATIONAL CONTROLLER

(71) Applicant: Dematic Corp., Grand Rapids, MI (US)

(72) Inventor: Clarissa Wade, Grand Rapids, MI (US)

(21) Appl. No.: 16/903,915

(22) Filed: Jun. 17, 2020

Related U.S. Application Data
(60) Provisional application No. 62/862,351, filed on Jun. 17, 2019.

(51) Int. Cl. G05B 15/02; G05B 19/05; H04L 29/06

(52) U.S. Cl. CPC G05B 15/02; G05B 2219/31457; H04L 69/04; G05B 19/05

(57) ABSTRACT

An electronic device configured to communicatively couple to a programmable logic controller (PLC). The electronic device includes a controller and a graphics processing unit (GPU). The controller is configured to receive signals from the PLC. The electronic device is configured to couple the controller to the PLC via a communications line. The received signals are extracted from the PLC by the controller. The GPU is configured to sample the received signals and to arrange the sampled signals as a graphical signal representation. The GPU is configured to process the graphical signal representation and prepare the processed graphical signal representation for transmission to a cloud-computing environment. The GPU is also configured to process the graphical signal representation to detect errors in the graphical signal representation which are indicative of errors in the process.

### CROSS REFERENCE TO RELATED APPLICATIONS

This application claims the filing benefit of U.S. provisional application, Ser. No. 62/862,351, filed on Jun. 17, 2019, which is hereby incorporated herein by reference in its entirety.

### FIELD OF THE INVENTION

The present invention is directed to programmable logic controllers (PLCs), and the monitoring of PLC controlled operations.

### BACKGROUND OF THE INVENTION

Conventional programmable logic controllers (PLCs), also referred to as programmable controllers, are hardened computers are often configured for control of manufacturing processes, assembly lines, order fulfillment systems, or automated devices, etc. Such PLCs include controllers communicatively coupled to input/output modules that are wired to electromechanical devices carrying out, and/or monitoring, those processes. The electromechanical devices transmit signals to the associated PLC (received by the PLC as input signals), via the input/output modules. In response to those input signals received from the electromechanical devices, the PLC controller is configured to output control signals to those electromechanical devices. That is, via the input/output signals communicated by the input/output modules to/from the PLC and the electromechanical devices, the PLC is able to monitor and control the processes carried out.

### SUMMARY OF THE INVENTION

An exemplary electronic device of the present invention is configured to communicatively couple to a programmable logic controller (PLC). The electronic device includes a controller and a graphics processing unit (GPU). The electronic device is configured to communicatively couple the controller to the PLC. The controller is configured to receive data signals from the PLC via a communications line. These data signals are forwarded by the controller to the GPU. The GPU is configured to arrange the received data as visual and/or graphical data, with the GPU then processing the graphical representation of that data. The GPU is further configured to select portions of the graphical representation and compress that selected portion for transmission to a cloud-computing environment.

An exemplary electronic device of the present invention is configured to communicatively couple to a programmable logic controller (PLC). The electronic device includes a controller and a graphics processing unit (GPU). The controller is configured to receive signals from the PLC. The electronic device is configured to couple the controller to the PLC via a communications line. The received signals are extracted from the PLC by the controller. The GPU is configured to sample the received signals and to arrange the sampled signals as a graphical signal representation. The GPU is configured to process the graphical signal representation and prepare the processed graphical signal representation for transmission to a cloud-computing environment.

An exemplary method of the present invention for sampling and processing input/output signals extracted from a programmable logic controller (PLC) includes coupling a controller of an electronic device to the PLC via a communications line. The method includes receiving, with the controller of the electronic device, signals from the PLC. A graphics processing unit (GPU) of the electronic device is used to sample the received signals and arrange the sampled signals as a graphical signal representation. The method also includes processing, with the GPU of the electronic device, the graphical signal representation and preparing the processed graphical signal representation for transmission to a cloud-computing environment.

In an aspect of the present invention, the GPU may be configured to process the graphical signal representation to detect errors in the graphical signal representation which are indicative of errors in the process. The GPU may also be configured to compare at least portions of the graphical signal representation to stored, previously recorded graphical signal representations to detect current errors based on previously discovered errors in the previously recorded graphical signal representations.

According to one aspect of the present invention, the communications line may be read only. In a further aspect, the communications line may couple to a backplane of the PLC.

According to another aspect of the present invention, the electronic device may include a memory configured for storing the data signals for later analysis.

According to yet another aspect of the present invention, the PLC includes a controller and a plurality of input/output modules. The controller and the plurality of input/output modules are communicatively coupled together via a backplane of the PLC. Each input/output module is configured to at least one of: receive signals from an electromechanical device and transmit control signals to the electromechanical device.

In still another aspect of the present invention, the GPU may be configured to compress the processed graphical signal representation before transmission to the cloud-computing environment.

In a further aspect of the present invention, the GPU may be configured to select a plurality of portions of the graphical signal representation. The GPU may also be configured to select the portions in parallel. The GPU may also be configured to individually compress each of the plurality of portions of the graphical signal representation.

These and other objects, advantages, purposes and features of the present invention will become apparent upon review of the following specification in conjunction with the drawings.

### BRIEF DESCRIPTION OF DRAWINGS

FIG. 1 is a block diagram of a feedback loop for a process for identifying errors and improving a process in accordance with an embodiment of the present invention;

FIG. 2 is a flow chart of the steps to a method for detecting errors in automated processes in accordance with an embodiment of the present invention

FIG. 3 is a block diagram of a programmable logistics cloud computational controller (PLCCC) communicatively coupled to a backplane of a PLC that is communicatively coupled to electromechanical devices controlling or monitoring a process in accordance with an embodiment of the present invention;

FIG. 4 is a block diagram of a process for receiving and evaluating control and data signals from a PLC with a GPU for further cloud-computing evaluation in accordance with an embodiment of the present invention;

FIG. 5 is a block diagram of a process for compressing portions of the control and data signals in accordance with an embodiment of the present invention;

FIG. 6 is a signal diagram illustrating the selection of portions of the control and data signals for data compression in accordance with an embodiment of the present invention; and

FIG. 7 is a signal diagram illustrating a process for evaluating and identifying errors in control and data signals received/output from a PLC in accordance with an embodiment of the present invention.

### DETAILED DESCRIPTION

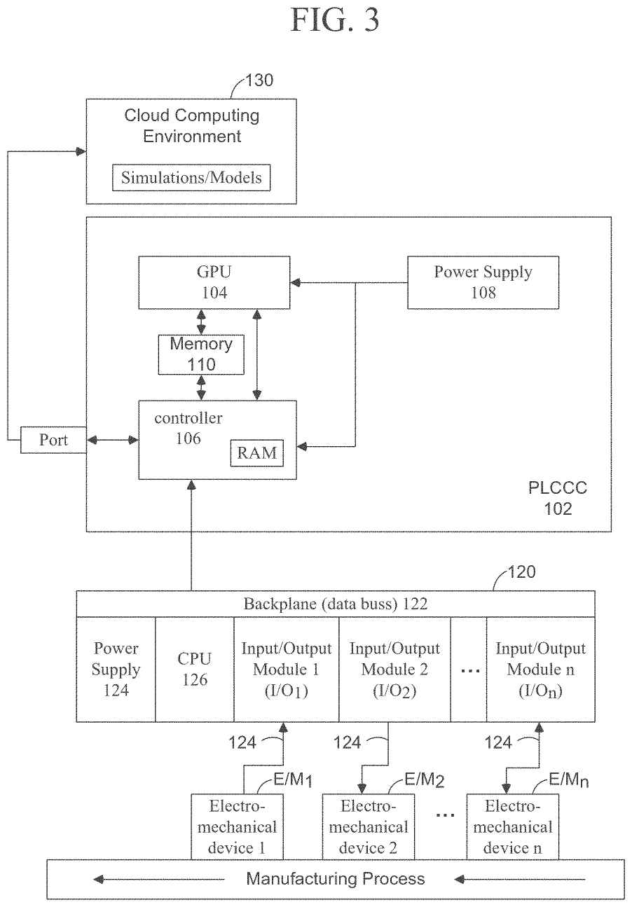

Referring now to the drawings and the illustrative embodiments depicted therein, a programmable logistics cloud computational controller (PLCCC) 102 communicatively coupled to a backplane 122 of a programmable logic controller (PLC) 120, which is communicatively coupled to electromechanical devices (E/M₁₋ₙ), are illustrated in FIG. 3. The electromechanical devices may also be referred to as mechatronic devices. The electromechanical devices E/M₁₋ₙ are configured to monitor and/or control a manufacturing process and/or industrial process. As discussed herein, the “manufacturing or industrial process” may be one of a variety of different processes or operations, such as processes carried out on assembly lines, automated devices, order fulfillment activities in a warehouse or similar facility, or other activities that utilize process control and monitoring methods. Hereinafter, these different processes and operations are generalized as a manufacturing process for the sake of convenience.

The PLCCC 102 of FIG. 3 comprises a controller 106 with an internal memory (RAM) that is coupled to a GPU 104. The controller 106 and the GPU 104 are communicatively coupled to a memory 110 configured to function as a buffer for the controller 106 and the GPU 104. The PLCCC 102 also includes one or more network ports (e.g., Ethernet and wireless connection ports) for communicatively connecting to an Internet based cloud-computing environment 130. As discussed herein, the cloud-computing environment 130 will be used to run one or more simulations and/or models of the manufacturing process or operational environment. The GPU 104 and controller 106 are both powered by an internal power supply 108 of the PLCCC 102. The power supply 108 may be configured to receive external power that is regulated by the power supply 108. As illustrated in FIG. 3, and discussed herein, the PLCCC 102 is communicatively coupled to the backplane 122 of the PLC 120. In one embodiment, the PLCCC 102 is an integral part of the PLC 120 and contained within the hardware of the PLC 120. For example, the PLCCC 102 may be implemented as a card that is inserted into a slot of the PLC 102 (much as input/output modules are inserted into slots of the PLC 102). In another embodiment, the PLCCC 102 is physically separate from the PLC 120 and requires a communications cable connecting the PLCCC 102 to the backplane 122 of the PLC 120.

The exemplary PLC 120 of FIG. 3 includes a plurality of input/output modules (I/O₁, I/O₂, I/Oₙ) and a processor (CPU) 126, each communicatively coupled to the PLC backplane 122. In one embodiment the PLC 120 includes a chassis/frame that contains the backplane 122 a means for individually mounting the CPU 126 and any input/output modules I/O₁₋ₙ. The input/output modules I/O₁₋ₙ are configured to receive respective control and/or data signals 124 from electromechanical devices (E/M₁₋ₙ) that monitor and/or control the manufacturing process or operational control environment. The PLC backplane 112 is a data buss providing for the transfer of data and control signals between the CPU 126 and the input/output modules I/O₁₋ₙ. The CPU 126 and input/output modules I/O₁₋ₙ are powered by an internal power supply 124. The power supply 124 may be configured to receive external power that is regulated by the power supply 124.

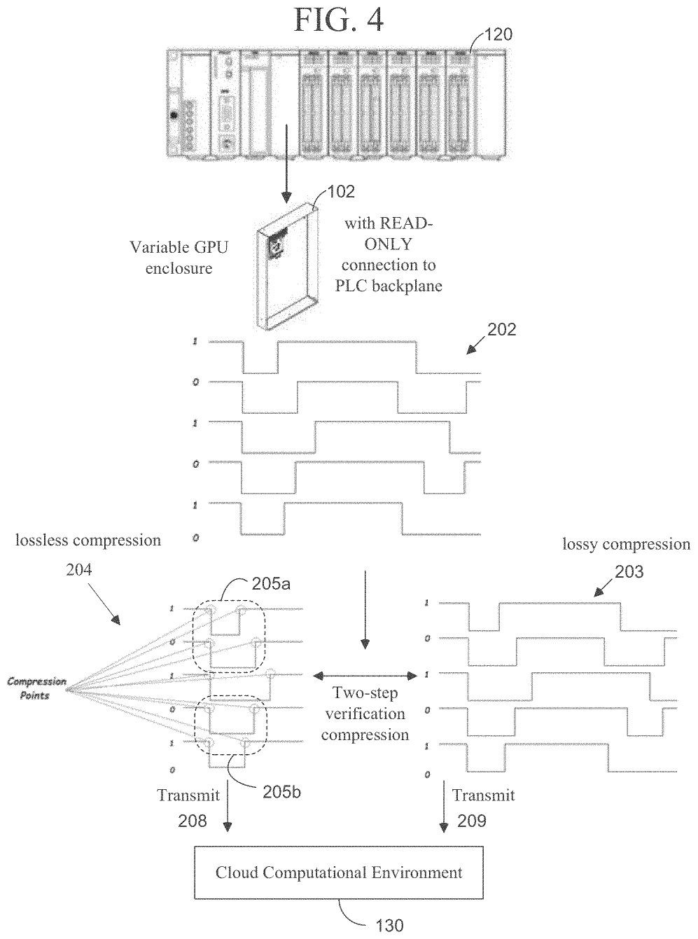

An exemplary PLCCC 102 is a logistics controller with the capability of translating and transmitting input/output data (124) in a reliable form for simulations/modeling carried out in a cloud-computing environment 310. As discussed herein, and illustrated in FIGS. 4-6, the data signals 124 carried by the backplane 122 are sampled, compressed and transmitted to the cloud computing environment 310. Using parallel processing techniques (e.g., GPU graphics processing operations), the PLCCC 102 is configured to extract the input/output data signals (124) received at the PLC's backplane (I/O interface or data buss) 122 on a given clock cycle, and passes along a compressed version of the data to the cloud computing environment 310 to be regenerated for use in multiple processing/evaluation applications. Alternatively, the PLCCC 102 may be configured to extract the input/output control and/or data signals 124 directly from a random-access memory (RAM) of the PLC 120 for the subsequent cloud computing environment-based processing/evaluation applications. Thus, the PLCCC 102 is configured to ensure that simulations (or models) running in those cloud environments 310 can operate directly off of the inputs and outputs of the manufacturing/operational processes and provides direct feedback to control systems of those processes without the necessity of expanding or exhausting local networks at the site of the manufacturing or operational process.

General Purpose Computing with GPUs:

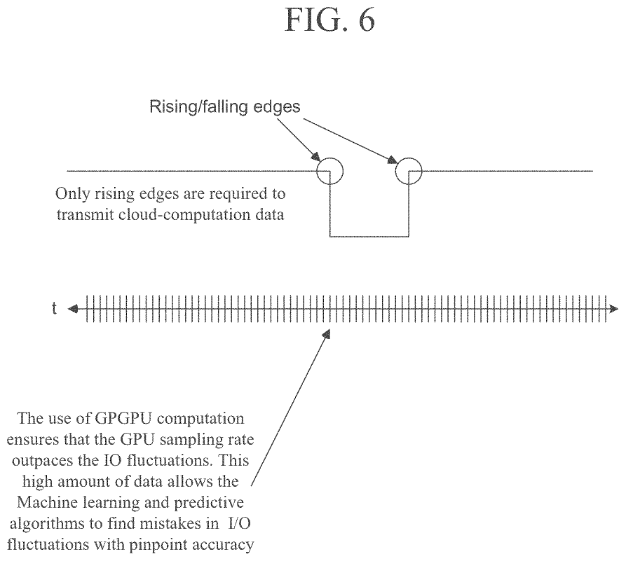

While conventional GPUs are usually considered to be functional components of video game systems, software simulation designs, including (but not limited to) video game cloud computing, console/client/cloud networks, machine learning, and artificial intelligence (AI) applications, GPUs can be alternatively configured for the parallel processing of data. When a typical GPU is used for such general-purpose computing, that is “GPGPU” computation, the data received by the GPU is analyzed as if it were in an image format or in some other graphical format. Because of their architecture, typical GPUs are capable of processing images and graphical data at a rate far greater than typical central processing units (CPUs) of conventional computers. Therefore, as discussed herein, the data extracted and sampled from a PLC's inputs/outputs may be migrated by the GPU into a graphical form and then scanned and analyzed as if that signal data was conventional visual/graphical data (see FIG. 4, where signals are analyzed as running calculations, such that they are analyzed by the GPU as if they are graphical data). With a sufficiently high sampling rate, the GPU will be able to identify each rising and/falling edge of a sampled incoming or outgoing signal (see FIG. 6). As discussed herein, hundreds of individual sections of sampled input/output signal traces may be compared to each other and to expected signal levels (as determined by algorithms controlling the basic selection and comparison of data sections).

### GPU Parallel Processing of Sampled Signals for Cloud-Computing Environment Based Simulations/Models:

A high sampling rate of the input/output data and control signals 124 provides a dependable time scale for data regeneration and provides for precise measurements beyond the capabilities of a traditional PLC design (i.e., beyond what any error detection and monitoring system in the PLC can accomplish). In an exemplary PLCCC 102, the GPU 104 can be configured to run at a speed that exceeds the PLC CPU clock cycle and so is able to take multiple measurements of the sensors and hardware outputs that the PLC 120 is connected to (e.g., the electromechanical devices E/M₁₋ₙ). Thus, at a hardware level, the processors are “asynchronous,” but with a GPU sampling rate sufficiently high enough to ensure that each rising and/or falling edge of the sampled incoming/outgoing signals are reliably captured. When a designer and/or manufacturer of a PLCCC 102 also designs and/or manufactures the PLC programs that run on the PLC's CPU 126, they would know the precise clock cycle that the program is expected to have. A response time to input changes is a combination of the firmware on the PLC 120 and of the software on the PLC 120. Thus, a sampling rate (for the GPU 104) may be selected based upon a known or estimated clock rate of the PLC's CPU 126 and thus of the speed at which the input/output signals 124 rise and fall. That is, the sampling rate is fast enough to sample each signal change (e.g., rising/falling edges) carried upon the backplane 122 (see FIG. 6).

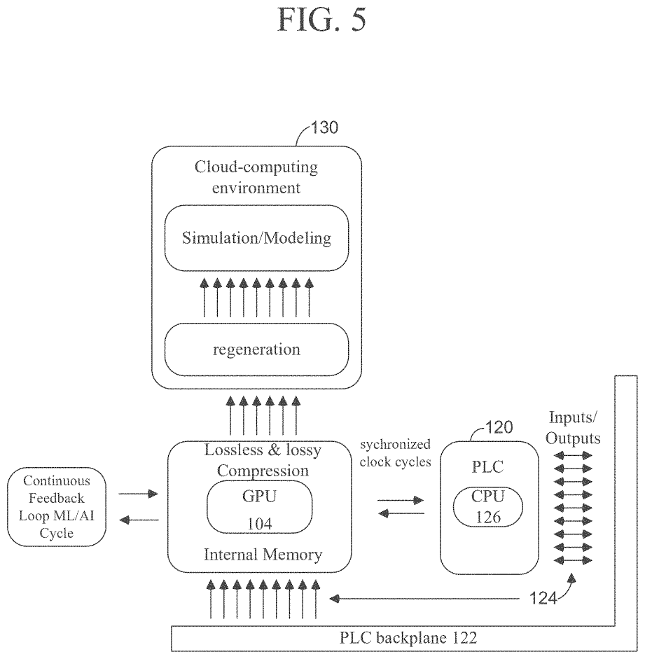

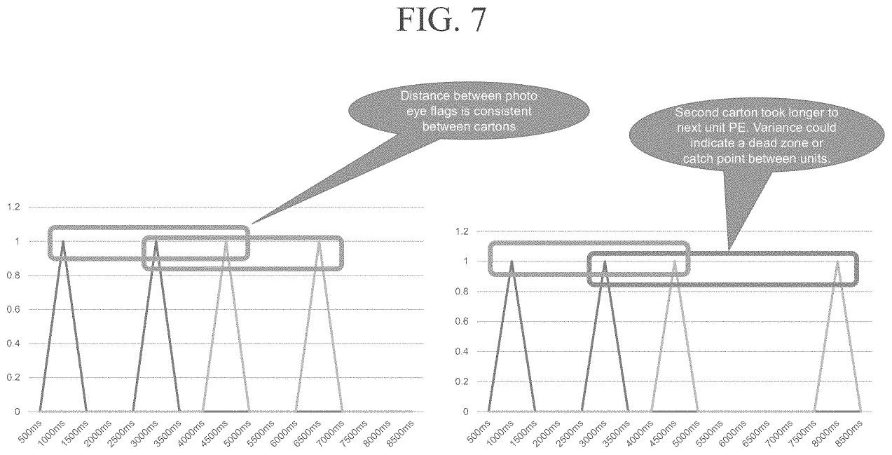

A “synchronization” between the GPU 104 and the PLC's CPU 126 occurs during the running measurements (graphical representation) of the inputs to the GPU 104 (see FIG. 5). Because those signals 124 are sampled by the GPU 104 so frequently, and because the time the PLC 120 takes to make decisions is a static value (once a control program has been finalized), the GPU 104 can detect when the fluctuation of PLC inputs (124) causes the program to throw an error (see FIG. 7). Or as discussed herein, the GPU 104 detects and tracks actions in the manufacturing process as they are occurring, allowing for the subsequent simulations/modeling to provide an interactive feedback to that ongoing manufacturing process.

For example, standard motor control programming blocks used in typical PLC logic behave in the same way and fashion at all times. Thus, errors are specific (e.g., a “motor fault,” a “jam,” and an “Estop”). The typical PLC can only tell what it knows about a program. However, if all the PLC inputs/outputs were sampled and evaluated, and not just the fault data, it would be possible to see what other variable(s) might have contributed to the problem. For example, a variety of different questions could be asked and answered. “Was a large amount of product passing along a belt?” “After counting the photo eye input pulses leading to the event, were they higher than normal?” “Is the equipment being used properly?” “Was the PLC program altered?” “Did an AUX signal return high initially and then trip the overload?” The answers to these questions can be used to identify the error and its source or cause. Embodiments of the present invention allow for such questions to be asked. As discussed herein, such questions (and possible answers) can be facilitated by the GPU scanning and selecting portions of the incoming and outgoing control and data signals that have been migrated into a graphical representation. Thus, as illustrated in FIG. 7, when a timing between an order fulfillment system's photo eye flags changes (indicating a change in distance between two particular cartons), which are generally consistent between cartons, it could indicate that when a particular carton took a longer time to reach a photo eye, that such a delay indicates a dead zone or a catch point between the cartons.

In combination with the GPU's high sampling rate, an exemplary two-step data compression method for compressing the processed data before transmission to the cloud-computing environment 130 is also used. A fast transfer (i.e., lossy compression (203)) may be used for visualization and predictive calculations. However, the addition of lossless compression (204) of just rising and/or falling edges (205a,b) of the input/output signals 124 lets the cloud implemented software compute runtime errors. Lossy compression 203 includes data compression methods that use approximations and data discarding of some of the data of an original file to represent the original file content. While the size of the data in the file can be reduced for transmission, the discarded data is permanently lost and cannot be restored. Meanwhile, lossless compression 204 includes data compression methods that compress a file size while maintaining picture quality of the graphics file. A lossless compressed file can also be decompressed back to its original quality.

Because the GPU 104 is continually running graphical representations to make its calculations, that graphical data can be captured periodically in “frames” of video data (such as the frame of data 202 in FIG. 4) which uses lossless compression 204 to pass data into the cloud 130 (see for example, the passage (208) of a compressed frame of data 204 to the cloud-computing environment 130 in FIG. 4). Such compression and data transfer is a highly predictive, highly efficient, and highly optimized method of data transference. While the highly precise asynchronous hardware measurements used for detailed error handling may be compromised, the resolution of the transferred file (203, 204) is enough to ensure the basic signal operations are understood with enough accuracy for predictive calculations to be performed (e.g., monitoring of machine specific functions and preprogrammed error signals).

For example, even if an exemplary resolution loss of a graph of signal traces causes rising/falling edges to slightly shift a millisecond or two, the resolution would be enough for PLC signals 124, such as “jam,” “motor fault,” and “estop,” etc. to be read (even if slightly delayed). The reduced detail is still sufficient for the real-time movement of boxes and such to be projected on a map of a fulfillment system. Even if the movement (of the boxes in the fulfillment system) is slightly skewed, it is a highly advanced data handling technique. This would theoretically enable the possibility of providing real time streaming of fulfillment system movement. For example, phones and smart watches of operators could be enabled to detect jams before the operators noticed the jams were there themselves. That is, the “high utilization and low utilization” of the fulfillment system, for a next hour, could be simulated and updated by the lower resolution of I/O data from previous days. Multiple pictures or “frames” (202) can be taken in a second, but each frame 202 contains repetitive measurements taken over the course of time the PLCCC 102 spends monitoring the fulfillment system behavior. Therefore, the compression is adaptive to the needs of the system. For example, in an exemplary automated system, to capture the high performance needs of a high-speed automation environment, 10-20 frames-per-second may be needed to capture the latest inputs/output signals 124 of the PLC 120. In an alternative slower moving automation system, a capture rate of only 1-5 frames-per-second may be acceptable in terms of providing a level of detail required to make real-time analytics possible.

In an exemplary second stage of the data transfer, the lossless compression 204 of the rising edges and critical data points (205a,b) are passed onto the cloud-computing environment 130. Depending on the file size and the network constraints of the automation system in question, this lossless compression method 204 can be scheduled to transfer (208) at optimal time intervals to minimize network impact or even passed on to a separate data storage facility on site. Therefore, the critical data evaluations of materials on site can be maintained even in non-optimal network circumstances.

Upon reaching the cloud-computing environment 130, the lossless compression transfer 204 (of the selected compression points 205a,b) is used to recursively “check” the “frames” of lossy compressed data in the cloud-computing environment 130. This creates a digital record of the detailed equipment behavior for post-processing of frame data. It ensures that the final stored information is accurate and maintains the detail required for analysis of the system. In short, this two-step calibration method combines the worlds of “real-time streaming” technology for immediate results as well as fine-grained metric data for calculations.

### Sampled Portions of Input/Output Data in Simulations/Models Used for Artificial Intelligence Techniques:

Such cloud computing environment 130 can also provide a storage program (e.g., a local memory 110 on the PLCCC 102, or a remote memory in the cloud-computing environment 130) to enable the analysis of long-term usage of the manufacturing system or process. Such is the basis for how AI techniques may be used (in the selection and evaluation of portions of graphical visualizations of the input/output signals carried on the backplane 122). For example, a full day's run of PLC inputs/outputs (previously recorded/stored in memory 110) can be run through a cloud-computing environment based analysis program (implementing AI techniques) to see how much downtime occurred, and to determine if service personnel performed maintenance if the equipment is throwing more faults than usual, etc.

As illustrated in FIGS. 3-5, the PLCCC 102 coupled to the PLC's backplane 122 allows for seamless connectivity between PLC environments and a cloud simulation environment through the interfacing process built into the PLCCC 102. This process isolates higher-order software applications (e.g., on the PLCCC 102) from interacting with live equipment configurations. This isolation eliminates the risk of disrupting the hardened PLC 120 from controlling critical safety operations in an automation system. Such a process may be considered continuous machine learning (ML) or artificial intelligence (AI). Namely, the algorithms developed in powerful cloud computing techniques can be condensed in post-processing and the PLCCC 102 can be taught the sensor profile corresponding to the error as it occurs in runtime. This profile amounts to little more than an image (e.g., a frame of data 202) of the input/output signals 124 stored in memory 110 of the PLCCC 102 which the software compares against the runtime behavior of the system. Therefore, the comparison of these error states and detection functions operate solely in the purview of the PLCCC 102 which contains a read-only connection to the hardware directly responsible for the mechatronics and so is not capable of directly influencing mechatronic movement which might result in hazardous operations. This eliminates the risk of a cybersecurity/cyberterrorism thread of cloud computing from the automation environment. While preserving the higher order detection and error handling that enables embodiments of the present invention to self-diagnose errors over time and to appear “intelligent,” hence terms for this device capability of ML and AI are directly applicable to the feedback loop methods discussed herein.

As another example, when an engineer observes a behavior in a sensor (e.g., E/M₁₋ₙ) that is faulty and files a report on the issue, this report can be catalogued. The signal history of the device/system at the time of the error can be used to develop a detection algorithm. The program in the controller 106 of the PLCCC 102 can then be updated to identify these problems in the future and replay them to the cloud computing environment 130 the instant the device/system detects this error, rather than waiting on time consuming processes such as: operational reports, service calls, information retrieval coordination by multiple parties, possible investigations of similar problems by disparate personnel, etc. Such a method can be used such that similar issues across all systems can be identified in a single instance, corrected in a singular instance, and updated across multiple devices which interface with multiple user sites to ensure that any similar problems can be detected and an accurate error report prepared automatically. Such a system and method, in accordance with the present invention, allows for the advancement of detection algorithms beyond industry standards to include new technology and new cloud alert monitoring (notifications) in an automation field.

### GPU-Based Data Processing Methods:

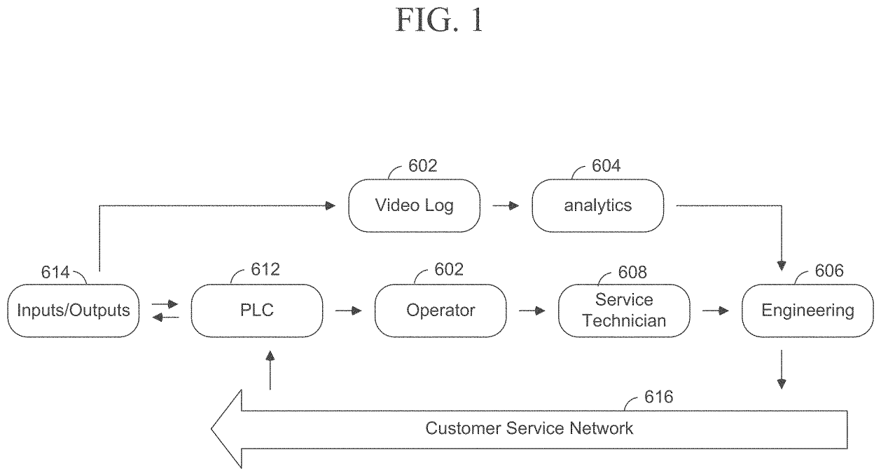

The resulting data extraction, sampling, graphical representation, evaluative processing, and delivery to cloud computing environments for simulations/modeling, may be considered a feedback loop. As illustrated in FIGS. 1, 4, and 5, multiple samples of live data 202 (the input/output signals 124 to be converted into a graphical format) are simultaneously and in parallel, sampled from input/output modules (I/O₁₋ₙ) of a PLC 120 (via the backplane 122) in real-time and provided to the cloud computing environment 130 for processing. Once considered as graphical data 202, portions 205a,b of the “graphical” live data 202 may be selectively extracted from the whole data set 202, compressed, and separately provided to the cloud computing environment 130 for analysis and/or simulation/modeling. While only two portions 205a,b of the data are illustrated in FIG. 4, hundreds of portions may be separately selected and processed in parallel. Because of the architecture of conventional GPUs, the GPU 104 of the present invention is able to select multiple portions 205a,b in parallel to be provided to the cloud computing environment 130. Thus, multiple portions 205a, 205b of the live sampled data 202 may be used to create a simulation/model (in a cloud-computing environment 130) that can be used to determine errors in the live manufacturing process as well as for considering changes to the real-world manufacturing process. Lastly, feedback from an evaluation of the simulation/model can be used to interact with the live system (e.g., the live manufacturing process or order fulfillment system) to alert the live system to specific errors with information and/or through changing the process (e.g., changing the routing of product in an order fulfillment system). As also discussed herein, GPU algorithms may also be used to select the portions 205a,b of the data 202, as well as to perform image comparisons of those portions 205a,b to other portions and to expected results (arranged as graphical representations) for particular error conditions, etc.

As illustrated in FIGS. 4 and 6, with the GPU's creation of a graphics environment for the sampled data 202 that was extracted from/on the PLC backplane data bus 122, this graphical data 202, as well as selected portions 205a,b of the data 202, are able to be exported for further processing utilizing a two-step verification compression method (using both lossy (203 and lossless (204) compression). As illustrated in FIG. 4, a lossy compressed version of the whole graphical data representation 202 of the sampled input/output signals 124 may be transmitted to the cloud-computing environment for visualization and predictive calculations. Meanwhile, selected portions 205a,b of that graphical data representation 202 of the sampled input/output signals 124 are compressed using lossless compression techniques 204. As discussed herein, and illustrated in FIGS. 4 and 6, an exemplary lossless compression technique 204 includes capturing and retaining just the rising and/or falling edges of the data (205a,b) along with their associated timing information (used for regenerating the original data 202). Thus, graphics data 202 that is exported in a usable format can be used to construct an animation engine (simulation/model) in the cloud-computing environment 130. This produces a simulation/model that is accurate to real world data and metrics.

Because of the use of GPU-based image processing, a variety of different data may be analyzed by embodiments of the present invention. For example, actual images from cameras may be captured and compared to expected results (e.g., camera images can be compressed till the images only show movement vectors, such that different movement vectors may be compared (to determine if an object is moving as expected)). Additional data can include inputs from video cameras, outputs from thermal sensors, hi/low signals from sensors, and others.

### Simulation/Model Control & Accuracy:

Conventional video game collision detection is about creating detection “boxes” or spheres around graphical objects. When the graphical representation is broken on a draw execution, it triggers a reaction in the software. This “box” is tied to the graphical representation of other objects within the game to outline the game's behavior. Note: not all hit boxes are the same, some hit boxes are broad to trigger animation events, while some are by necessity, very small and are responsible for transmittal of critical core pieces of information. By coupling this method with high fidelity signal modeling of equipment movement provided by the PLCCC 102, these “event triggers” can be used to coordinate data manipulations across large scale cloud computational networks with real-time system movement for a wealth of new calculations.

High fidelity simulation systems are used in broad categories of technological innovation and human interaction with complex system variables. The addition of the PLCCC 102 provides speed and minimizes network footprints to ensure that the data is made available for use in high performance mathematical modeling of automation system movement. Furthermore, the cloud hosting of this technology makes replication of the virtual environments simple and cost effective for a wide variety of solutions. Thus, the use of a PLCCC 102 coupled to the input/outputs of a PLC backplane 122 ensures low cost high powered simulation technology that was previously only available in the “gaming” sector can be used to analyze, diagnose, and handle a wide variety of automation processes. Having the simulations hosted in the cloud (e.g., the cloud computing environment 130) and updated via real-time transference of the data processing methods discussed herein as a component of the PLCCC 102, enables a wide variety of users/operators to perform operations digitally that previously required extensive travel costs and overly large human footprints, all without representing risk to the automation facilities themselves. Embodiments of the present invention enable a single company using the PLCCC 102 to access a wider variety of resources using established and proven data handling methods.

The graphical representation of signals (e.g., the sampled input/output signals 124) compiled for running analysis is a “running comparison.” That is to say that the digital recording of these values is optimized to blur the line between digital and analog signal analysis. These comparisons of “snap shot” data to expected operational data representations can be performed with scheduled routine image comparison algorithms in the GPU 104 to preserve information transference rates. Additional graphical representations and image comparison methods can be compounded into the PLCCC processes over time through firmware and software upgrades to improve efficiencies in data handling and error detection in the wide variety of PLC applications. This ensures that while the machine footprint of the automation system is a variable to simulation environments, the fidelity of the mathematical modeling and error detection is maintained in the self-contained PLCCC 102. This exemplary architecture (of the PLCCC 102 and its connections to the PLC backplane 122) ensures that across any automation application that uses PLC controller technology, the PLCCC platform of the present invention is able to effectively operate and perform the full range of its technical services. The only aspect of the PLCCC 102 that changes between PLC manufacturers and companies is the communications cable that is responsible for the initial connection of the PLCCC 102 to the PLC backplane data buss 122. In an aspect of the present invention, the algorithms are executed by the GPU 104, such that the real time input/output signals 124 found on the backplane 122 may be analyzed according to one or more algorithms. In a further aspect of the present invention, those selected portions 205a,b may be placed into a cloud-computing environment 130, where engineers may analyze the data to monitor the signal traces of critical signals to detect error conditions, such that the signal traces may be “rewound” and played back to watch the error condition “reoccur.”

While an exemplary GPU 104 may create and run a continuous model of the sampled real-time input/output signals 124, such that portions 205a,b of the sampled graphical signal representation 202 may be compared or analyzed, those portions 205a,b of data may be stored in the cloud-computing environment 130 for simulation/modeling. Furthermore, based upon the cloud-computing environment based modeling, an algorithm or instruction (which is hardware specific) may be sent to the GPU 104 monitoring the real time input/output signals 124 to sample and compare particular selected portions 205a,b to other portions or to expected results or to previously recorded “error” data. This ensures that the critical performance benchmarks of the PLCCC 102 are maintained in an industrial automation cross platform environment.

### Advantages of Simulation Control Environments:

Object oriented programming allows for a single central model to process all sortation and routing instructions (seen in an exemplary order fulfillment process) independent of PLC tracking methods which makes higher order software functions possible. Executing a model or simulation in a cloud computing environment can ensure that any patches and updates to the simulation/model can be directly applied to the software to maintain cutting edge software techniques and maximize performance while minimizing design time. Animations engines that are executed in such cloud computing environments may be maintained and carried over to a next generation on every project such that each project uses the same techniques (e.g., the same sorting techniques in an exemplary order fulfillment process). Thus, the vast majority of software applications can be “pre-baked” into the model creation and software developers can invest their time customizing core operational models (e.g., sortation models in an order fulfillment process), providing test patterns and emulation of events directly on the platform that controls the machinery of the manufacturing process or order fulfillment system.

### Real-Time High-Performance Visualization:

When it comes to visualization display technology, industrial systems often fail to utilize even the most basic graphical technology. Real-time data streams can be harnessed to create, for example, realistic warehouse models that take advantage of real-time simulation efforts. More than just emulation, using virtual environments to display information about the system allows service/repair technicians to playback/rewind the environment (as sampled and recorded as graphical data by a GPU 104) to better diagnose downtime in the live system.

As illustrated in FIG. 1, downtime in customer systems (block 616) can be reduced by actively monitoring threats/errors. Digital recording (block 602), via the GPU 104, and analytics (block 604), e.g., simulations and modeling in the cloud-computing environment 130, can monitor systems independently of any site system control or operator assessment (blocks 602 and 608). As illustrated in blocks 612 and 614, the inputs/outputs 124 are sampled by the GPU 104 and processed (the input/output signals are converted into a graphical signal representation) such that a plurality of portions of the graphical signal representation may be selectively uploaded to the cloud-computing environment 130 for analytical review. This analytical review may then be used in providing feedback (e.g., to an engineering department making changes to a system or method (block 606)) when errors are detected. As also illustrated in FIG. 1, such data sampling and analytics takes place independent of any analysis and review of on-site operators and service technicians (blocks 602 and 608).

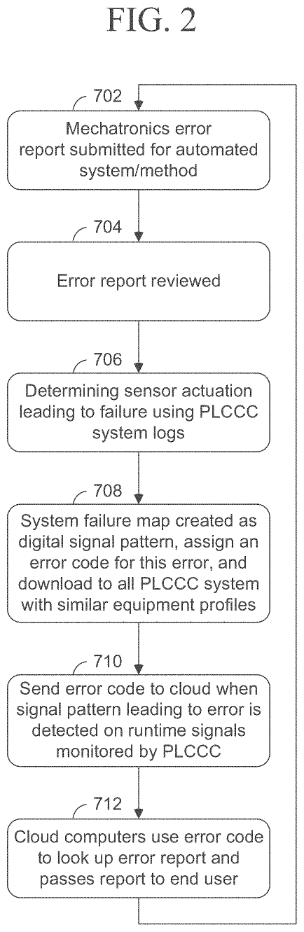

FIG. 2 also illustrates the steps to the error detection methods. For example, in step 702 of FIG. 2, the customer service department of an automation provider is contacted about a particular mechatronics failure or error that is reported by an automation system/method end user. In step 704 of FIG. 2, an engineer inspects the error report and files a digital report of the problem. This digital report may also include a time table for when the issue occurred. In step 706 of FIG. 2, a software engineer reviews the error report and time table for the error, and determines sensor actuations leading to the failure using system logs that are generated by the PLCCC 102. In step 708 of FIG. 2, a system failure map is created as a digital signal pattern. An error code is assigned that corresponds to the particular error (represented by the digital signal pattern), and the digital signal pattern and corresponding error code are downloaded to all PLCCC systems with similar equipment profiles (and capable of reproducing the same error). In step 710 of FIG. 2, during operation of the automation system/method, when a signal pattern leading to the error is detected on the extracted/sampled runtime signals (input/output signals 124), an error code is sent by the PLCCC system 102 to the cloud (130). In step 712 of FIG. 2, the cloud-computing environment 130 uses the reported error code to look up an error report that was filed in step 706. This error report is passed to the end user as a system self-diagnosis of the error. The error detection process then returns to step 702.

Note that because the failure map is compiled on digital signals in the PLC backplane 122, it is a direct representation of the underlying mechatronics of the automation system. Therefore, the failure pattern calculated in step 708 is valid for multiple system types, and is independent of the control systems (PLC) operating the mechatronics. The PLCCC 102 computes errors directly affecting the mechatronics and can diagnose system errors without needing to be “reprogrammed” for each system.

Furthermore, embodiments of the present invention enable backwards compatibility for, for example, micro order fulfillment designs (tracking of individual packages moving through the system) on older order fulfillment systems. The 110 interface (the PLC backplane data bus) of even an older system may be tapped by a PLCCC, when the PLCCC and its connections to the PLC backplane are added to the older equipment models. This allows for a tracked package to have its destination changed in the middle of its flow. An exemplary embodiment of the present invention includes a design small and/or flexible enough to fit into a typical control cabinet architecture.

Similarly, future models of PLC technology may be integrated into the PLCCC's adaptability and design through the use of GPGPU computational technology, as described herein. The PLCCC 102 is designed to house any of a variety of GPU designs which are upgradable depending upon the speed and operational capacity of the PLC designs they are intended to monitor. Any interaction of PLC technology representing an increased performance or technological innovation does not require an adaptation of the PLCCC design as long as the PLC 120 contains a readable backplane data buss 122 carrying sensor inputs and outputs that are monitored in a central location. GPUs, such as those described herein, are specialized for performance and are continually updated with commercial designs that fit a singular dimensional space that the PLCCC 102 can house. Therefore, the PLCCC's performance comes from the GPU vs. CPU performance metric which allows GPUs to outpace CPU calculations on widespread recursive mathematical functions.

Therefore, embodiments of the present invention enable PLC logs to be gathered and stored into a cloud computing environment over Internet of Things (TOT). As well as enabling dynamic playback of system simulations and model history to better diagnose system errors and downtime. The embodiments described herein also enable live monitoring of equipment through standardized visual detection of errors directly transmitted to engineering services, a system manager, or a local maintenance team. The 110 signal samples can be visualized and processed by GPU processes as visual data. These embodiments enable graphic movement-oriented applications to unify data collections and allow for new technologies to be unified in a single system control. The exemplary embodiments of the present invention may utilize parallel processing techniques that allow PLC data to bypass PLC peripheral software and connection requires through direct interface reading of sensor I/O data points, and to directly compress and transmit this data to a cloud server with minimal network requirements. In an aspect of the present invention, the PLCCC can act as a client station at the PLC, processing the data and containing it in a buffer until transmitted to the cloud. Thus, data analysis in a cloud computing environment reduces local server requires for on-site equipment. The required cloud computing environment can be updated and modified locally by the controlling entity. Furthermore, new services can be introduced, tested virtually, and finally commission on a single unifying platform. Such cloud computing of the simulation environment allows for independent feedback from external systems that share the environment for data calculations. Thus, many systems that utilize PLC system for manufacturing, order fulfillment, autonomous control, and other systems could benefit from cloud driven computations.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments. Changes and modifications in the specifically-described embodiments may be carried out without departing from the principles of the present invention, which is intended to be limited only by the scope of the appended claims as interpreted according to the principles of patent law including the doctrine of equivalents.

1. An electronic device configured to communicatively couple to a programmable logic controller (PLC) controlling and monitoring a process, the electronic device comprising:
a controller configured to receive signals from the PLC, wherein the electronic device is configured to couple the controller to the PLC via a communications line, and wherein the received signals are extracted from the PLC by the controller; and
a graphics processing unit (GPU) configured to sample the received signals, and to arrange the sampled signals as a graphical signal representation;
wherein the GPU is configured to process the graphical signal representation and prepare the processed graphical signal representation for transmission to a cloud-computing environment.

2. The electronic device of claim 1, wherein the GPU is configured to compress the processed graphical signal representation before transmission to the cloud-computing environment, and wherein the compression of the processed graphical signal representation comprises lossy compression.

3. The electronic device of claim 1, wherein the GPU is configured to select a plurality of portions of the graphical signal representation, and wherein the GPU is configured to select the portions in parallel.

4. The electronic device of claim 3, wherein the GPU is configured to individually compress each of the plurality of portions of the graphical signal representation, and wherein the compression of the processed plurality of portions of the graphical signal representation comprises lossless compression.

5. The electronic device of claim 1, wherein the signals are at least one input signals and output signals, and wherein the signals are at least one of data signals and control signals.

6. The electronic device of claim 5, wherein the PLC comprises a backplane communicatively coupled to a plurality of input/output modules, each coupled to at least one electromechanical device, and wherein the input signals are signals from ones of the input/output modules to a controller of the PLC, wherein the output signals are signals from the controller of the PLC to ones of the input/output modules, and wherein the communications line is coupled to the backplane, and wherein the communications line is read-only.

7. The electronic device of claim 1 further comprising a memory configured to store the graphical signal representation for later processing.

8. A method for sampling and processing input/output signals extracted from a a programmable logic controller (PLC), the method comprising:
coupling a controller of an electronic device to the PLC via a communications line;
receiving, with the controller of the electronic device, signals from the PLC;
sampling, with a graphics processing unit (GPU) of the electronic device, the received signals and arranging the sampled signals as a graphical signal representation; and
processing, with the GPU of the electronic device, the graphical signal representation and preparing the processed graphical signal representation for transmission to a cloud-computing environment.

9. The method of claim 8, wherein receiving signals comprises extracting, with the controller of the electronic device, signals from the PLC.

10. The method of claim 8 further comprising compressing, with the GPU, the processed graphical signal representation before transmission to the cloud-computing environment, and wherein compressing the processed graphical signal representation comprises compressing with a lossy compression technique.

11. The method of claim 8 further comprising selecting, with the controller of the electronic device, a plurality of portions of the graphics signal representation, and wherein the portions are selected in parallel.

12. The method of claim 11 further comprising individually compressing each of the plurality of portions of the graphics signal representation.

13. The method of claim 12, wherein individually compressing each of the plurality of portions of the graphics signal representation comprises compressing with a lossless compression technique.

14. An electronic device configured to communicatively couple to a programmable logic controller (PLC) controlling and monitoring a process, the electronic device comprising:
a controller configured to receive signals from the PLC, wherein the electronic device is configured to couple the controller to the PLC via a read only communications line, and wherein the received signals are extracted from the PLC by the controller; and
a graphics processing unit (GPU) configured to sample the received signals, and to arrange the sampled signals as a graphical signal representation;
wherein the GPU is configured to process the graphical signal representation to detect errors in the graphical signal representation which are indicative of errors in the process.

15. The electronic device of claim 14, wherein the GPU is configured to compare at least portions of the graphical signal representation to stored, previously recorded graphical signal representations to detect current errors based on previously discovered errors in the previously recorded graphical signal representations.

16. The electronic device of claim 15, wherein the GPU is configured to prepare the processed graphical signal representation for transmission to a cloud-computing environment.

17. The electronic device of claim 16, wherein the GPU is configured to compress the processed graphical signal representation before transmission to the cloud-computing environment, and wherein the compression of the processed graphical signal representation comprises lossy compression.

18. The electronic device of claim 17, wherein the GPU is configured to select a plurality of portions of the graphical signal representation, wherein the GPU is configured to select the portions in parallel, and wherein the GPU is configured to individually compress each of the plurality of portions of the graphical signal representation, and wherein the compression of the processed plurality of portions of the graphical signal representation comprises lossless compression.

19. The electronic device of claim 18, wherein the signals are at least one input signals and output signals, and wherein the signals are at least one of data signals and control signals.

20. The electronic device of claim 19, wherein the PLC comprises a backplane communicatively coupled to a plurality of input/output modules, each coupled to at least one electromechanical device, and wherein the input signals are signals from ones of the input/output modules to a controller of the PLC, and wherein the output signals are signals from the controller of the PLC to ones of the input/output modules.
